(19) United States
(12) Patent Application Publication
(10) Pub. No.: US 2019/0383573 A1
(43) Pub. Date: Dec. 19, 2019

(54) DEVICE FOR MEASURING THE RHYTHM AND RATE OF FIRE OF A WEAPON

(71) Applicant: FN Herstal S.A., HERSTAL (BE)

(72) Inventors: Hugues Libotte, Jalhay (BE); Thierry Bodeus, Melen (BE)

(21) Appl. No.: 16/489,473

(22) PCT Filed: Feb. 28, 2018
(86) PCT No.: PCT/EP2018/054946

§ 371 Date: Aug. 28, 2019

(30) Foreign Application Priority Data
Feb. 28, 2017 (BE) 2017/5120

(51) Int. Cl. F41A 19/01; G06M 1/10

(52) U.S. Cl. CPC F41A 19/01; F41A 31/00; G06M 1/10

(57) ABSTRACT

The present invention relates to a device for measuring the rhythm and/or rate of fire for all types of weapon, comprising:—a self-powered system (2) able to recuperate the energy of the firing,—at least one RC accumulation network (3) comprising a capacitor (5) and a resistor (6) in parallel, —an element that measures the voltage across the terminals of the capacitor; characterized in that the self-powered system (2) charges said capacitor (5) upon each firing.

### SUBJECT OF THE INVENTION

The present invention relates to a device for measuring the effective and cyclic rates of fire of a weapon.

The present invention also relates to any type of weapon including this device.

The present invention further relates to a method for measuring the effective and cyclic rates of fire of a weapon.

### PRIOR ART

The wear on a weapon and hence the maintenance to be performed depends in particular on the effective rate of fire. The effective rate of fire is the number of shots fired by the user over a given time period. Consequently, the effective rate of fire is representative of how intensively the weapon is used and, as such, among other things, of barrel heating. This heating is itself representative, for example, of the wear caused on the weapon.

Meanwhile, the cyclic rate of fire is an intrinsic characteristic of the weapon that is representative of the frequency of its natural mechanical cycle of operation. The cyclic rate of fire of a poorly lubricated or fouled weapon is decreased, which may be problematic and result in a firing malfunction.

Measuring these two parameters is therefore advantageous for weapon maintenance. Currently, they are measured by devices that are supplied with power by batteries and that comprise an internal clock. Specifically, measuring these two parameters using a batteryless device is difficult, given the relatively long and unpredictable times between two events. It is therefore unrealistic to expect to produce enough energy from one firing to be able to wait for the next.

There are weapon shot-counting devices that operate by recovering energy from firing. Document WO 2016142444 A1 presents a shot-counting device for a weapon for the purpose of determining its state of wear. This device uses an electronic circuit and a motion sensor to detect the number and type of shots fired. The electrical circuit may be supplied with power by energy recovery.

However, energy recovery devices are generally unsuitable for measuring the effective or cyclic rate of fire.

By way of example, the following three methods are suitable for energy recovery in a weapon:

the use of an element of the weapon that is set in motion when firing (i.e. moving a magnetic part through a solenoid);

the use of the thermoelectric effect;

the use of the piezoelectric effect.

Document EP 2 573 498 discloses an electric power generator that transforms the mechanical energy from firing a shot into an electric current for supplying the shot counter of a firearm with power. The (mechanical, vibrational, etc.) motion or other (thermal, acoustic, etc.) phenomena during firing are transformed into an electrical signal, which is subsequently delivered to the shot counter.

Document U.S. Pat. No. 8,290,747 discloses an electronic system for recording an event using a sensor that delivers mechanical energy to a structure comprising an electronic memory. All of the energy for detecting the event and for recording the event in the electronic memory is derived from the mechanical energy. This document also describes a device comprising a piezoelectric transducer and a memory. A signal from the piezoelectric transducer (which crosses a certain threshold) will allow the memory to change state. All of the energy for changing the state of the memory is derived from this signal.

### OBJECT OF THE INVENTION

The object of the present invention is to produce a device capable of measuring effective and cyclic rates of fire of a weapon by means of a passive electrical network requiring no supply of power other than that supplied by firing.

By virtue of the device of the invention, it will be possible to calculate the cyclic and effective rates of fire without the need for an external power supply such as for example a cell or a battery.

Such a device according to the invention allows the weapon to be monitored continuously and ensures the efficiency, longevity and safety thereof through improved maintenance. Specifically, this device makes it possible to assess the heating of the barrel and of other parts of the weapon and hence to check the state of wear thereof by calculating the effective rate of fire of the weapon.

### SUMMARY OF THE INVENTION

The present invention relates to a device for measuring the effective and/or cycle rate of fire for any type of weapon, in particular a firearm, comprising:

a self-powered system capable of recovering energy from firing;

at least one RC accumulator network comprising a capacitor and a resistor in parallel;

an element measuring the voltage across the terminals of the capacitor; the self-powered system charging the capacitor on each firing, the cyclic or the effective rate of fire being determined by the residual charge across the terminals of the capacitor when firing.

According to preferred embodiments of the invention, the device includes at least one or an appropriate combination of the following features:

the self-powered device is configured so as either to inject a predetermined constant charge on each firing or to impose a constant difference in potential across the terminals of the capacitor on each firing;

the time constant of the RC accumulator network is chosen to represent dynamics of the effective rate of fire or dynamics of the cyclic rate of fire;

the voltage measurement element comprises an electronic device comprising optocouplers that are intended to measure the value of the difference in potential of the capacitor;

the device of the invention comprises an electronic device for calculating the cyclic rate of fire and/or the effective rate of fire on the basis of the value measured by the element for measuring the difference in potential;

the device of the invention comprises a storage memory making it possible, in use, to store the value of the difference in potential across the terminals of the capacitor during a later firing;

the self-powered system comprises a shot counter.

The present invention also relates to a weapon including at least one measurement device such as described above.

According to one variant, the weapon is fitted with one device for measuring the effective rate of fire and with another device for measuring the cyclic rate of fire. The present invention further relates to a method for measuring the effective and/or cyclic rate of fire for any type of weapon, comprising the following steps:

recovering energy from firing;

injecting a predetermined charge into the capacitor using said energy or applying a predetermined voltage across the terminals of the capacitor;

gradually discharging the capacitor through the resistor;

measuring the difference in potential across the terminals of the capacitor during the next firing, before the step of charging the capacitor.

According to one preferred embodiment of the invention, the measurement method comprises an additional step of either calculating the cyclic rate of fire or of calculating the effective rate of fire on the basis of the difference in potential across the terminals of the capacitor.

Advantageously, the method of the invention comprises a step of recording the voltage across the terminals of the capacitor before it is recharged.

### BRIEF DESCRIPTION OF THE FIGURES

FIG. 1 shows a diagram of the measurement-taking steps.

FIG. 2 shows a diagram for a circuit for measuring the cyclic and effective rates of fire according to the invention.

FIG. 3 shows one particular example (RC=0.18 s and V₀=1 V) of a discharge curve of the RC network for measuring the cyclic rate of fire.

FIG. 4 shows one particular example (RC=60 s and V₀=1 V) of a discharge curve of the RC network for measuring the effective rate of fire.

### DETAILED DESCRIPTION OF THE INVENTION

The device according to the invention measures either the effective or the cyclic rate of fire of a weapon. This device can be adapted for any type of portable, automatic or semi-automatic firearm (rifle, pistol, machine gun, submachine gun, etc.).

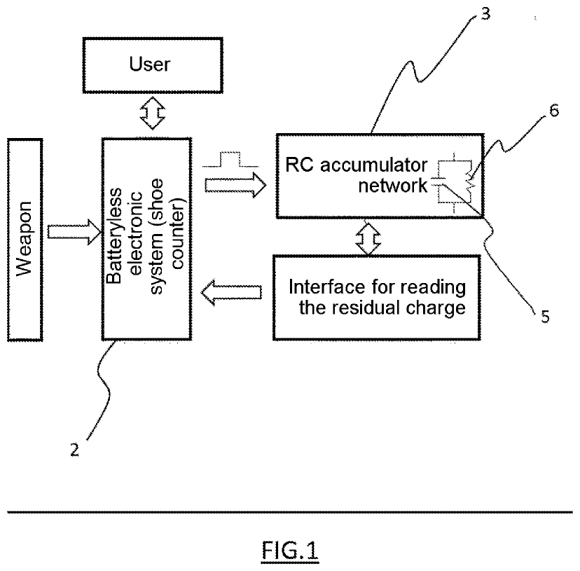

The device, as shown in FIG. 1, comprises a self-powered system 2 that is capable of recovering energy from firing for the purpose of supplying power to at least one RC accumulator network 3 comprising a capacitor 5 and a resistor 6 in parallel.

The self-powered system 2 allows a portion of the energy from firing to be recovered and a predetermined charge to be injected into said capacitor 5.

In one particular application of the invention, the self-powered system 2 may be a shot-counting system. This type of system is well known from the prior art and makes it possible to measure and to record a certain number of parameters related to a particular firing by recovering energy from each firing to supply itself with power. In general, if it is without a battery, such a shot-counting system turns off once firing has ceased, waiting for the next bout and the energy produced thereby. Without compromising the effective operation of this system, a portion of this energy may be used to inject a predefined charge into the capacitor of the invention.

The capacitor 5 is associated, in parallel, with a discharge resistor 6 for discharging the capacitor 5 gradually and in a controlled manner.

A different circuit must be provided for each type of measured value, i.e. either the cyclic or the effective rate of fire. However, two devices may be included within one and the same weapon for the purpose of measuring both values.

It is well known that a capacitor, coupled to a discharge resistor, exhibits an exponential decrease in voltage with time according to the equation U=U₀.e^{-t/RC}, while the initial voltage U₀ is dependent on the charge Q injected into the capacitor according to the equation U₀=Q/C.

When several consecutive shots are fired in the case of constant charge injection (i.e. when a shot is fired while the capacitor is still charged), the voltage across the terminals immediately after the i^{th} firing is given by the following equation:

Uᵢ=Uᵢ₋₁.e^{-Δt}^{ᵢ}^{/RC}+Q/C

The first term in this sum is representative of the residual charge immediately before the i^{th} firing, and the term Q/C is representative of the increase in the difference in potential due to the injection of the predetermined charge Q. In this case, for periods of time that are short with respect to the RC time constant (i.e. there is not enough time for the capacitor to be discharged by any substantial amount), the voltage increases on each firing.

When a constant difference in potential is imposed on each firing, however, the term Q/C disappears and the equation becomes:

Uᵢ=U₀.e^{-Δt}^{ᵢ}/RC

It may therefore be seen that injecting a constant charge allows a measurement that takes successive firings into account, with a buildup of charge over several firings as long as they are close together in relation to the RC time constant. However, when applying a constant voltage on each firing, the voltage across the terminals of the capacitor measures only the last time period, which is particularly well-suited to measuring cyclic rates of fire.

The resulting time constant of this circuit is determined so as to be representative of the dynamics of the phenomenon to be measured, namely either the cyclic rate of fire (from 0.01 s to 0.3 s) or the effective rate of fire (between 1 minute and one hour depending on the geometry and the size of the system to be monitored). In this way, the discharge time of the circuit will be matched to the desired measurement. The value of the difference in potential then makes it possible to determine the time elapsed since the preceding firing.

In the case of measuring the cyclic rate of fire, the object is to measure the time between two successive firings in order to determine the frequency of the natural mechanical cycle of the weapon. This time is relatively short because, on average, a weapon firing in automatic mode fires between 250 and 5000 rounds per minute. The measurement of the time elapsed since the final shot may be calculated by means of the value of the potential across the terminals of the capacitor 5 using the discharge curve of the RC network 3.

In the case of measuring the effective rate of fire, the number of shots fired by the user over a time period, and hence the heating of the barrel, is calculated. In this situation, the RC network 3 of the device is used as an electrical model of the thermal behavior of the barrel. On each firing, some of the heat is absorbed by the barrel, which heats up. This is simulated by the voltage across the terminals of the capacitor 5, which is then representative of the heat capacity of the barrel. However, at the same time, the barrel exchanges heat with the surrounding air to cool down, which is simulated by the resistor 6 which provides a leakage current for the charge built up in the capacitor 5.

As shots are fired over the determined time period, calibrated charges are transmitted to the capacitor 5 and the voltage across the terminals thereof increases so as to reflect the thermal behavior of the barrel. Some current from the capacitor 5 is dissipated by the resistor 6, allowing the cooling of the barrel by the surrounding air to be modeled. Ultimately, the difference in potential measured across the terminals of the capacitor 5 after a certain amount of time is representative of a measurement of barrel heating.

Additionally, the measurement device comprises an electronic device that is based, for example, on optocouplers that are capable of reading the value of the difference in potential across the terminals of the capacitor without discharging it and hence distorting the measurement. This assembly also provides excellent thermal stability for the measurement.

According to one preferred embodiment of the invention, the measurement device comprises an electronic device that is capable of calculating and displaying the cyclic and/or effective rate of fire on the basis of the value measured by the optocouplers. In this way, the user may view the displayed results.

The device therefore makes it possible to measure the time between firings and to do so without the associated system needing to stay powered.

The invention also relates to a method for measuring the effective and/or cyclic rate of fire for any type of weapon. This method comprises various steps.

First, the self-powered system recovers energy from firing for the purpose of charging the capacitor 5 with a portion of this energy.

The capacitor will be discharged gradually and in a controlled manner through the resistor 6, which is connected in parallel to the capacitor 5 in the circuit. Next, the difference in potential across the terminals of the capacitor 5 is measured by an electronic device that is preferably based on optocouplers, thereby allowing either the effective rate of fire or the cyclic rate of fire to be calculated according to the measurement device.

The weapon of the invention may comprise either a device for measuring the cyclic rate of fire or a device for measuring the effective rate of fire or, of course, both devices.

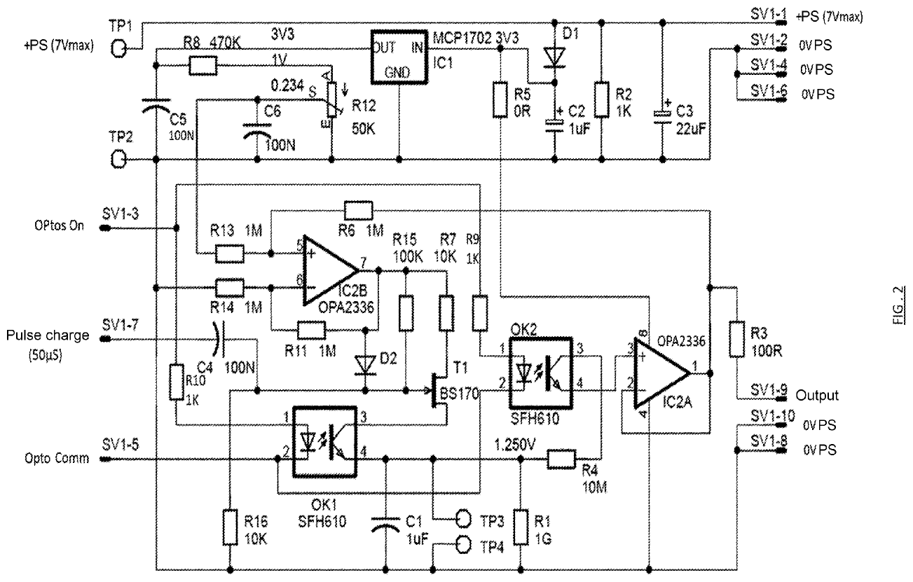

FIG. 2 shows a diagram for a circuit for measuring the cyclic and effective rates of fire according to the invention.

### EXAMPLES

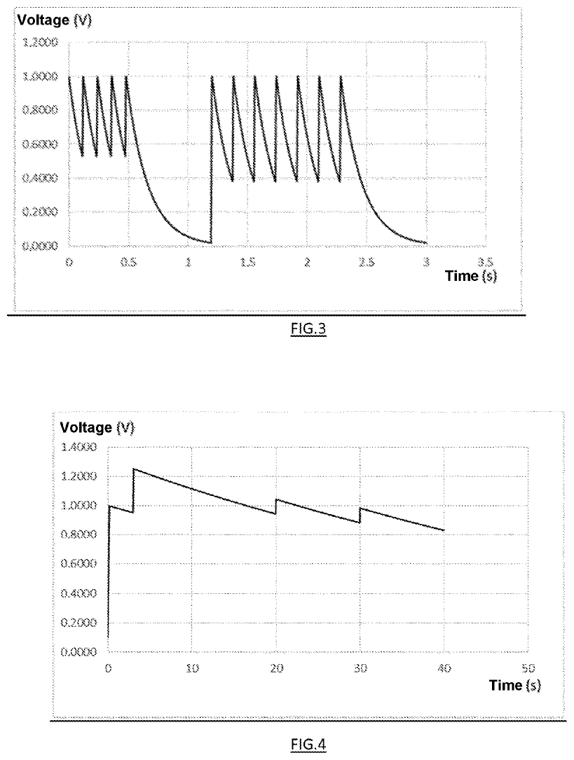

FIG. 3 shows one particular example of a discharge curve of the RC network for measuring the cyclic rate of fire. In this figure, the voltage V across the terminals of the capacitor (on the y-axis) is shown as a function of time t (on the x-axis). Specific values have been chosen for this example, the initial voltage Vₒ being 1 volt and the constant of the RC circuit being 0.18 sec.

To result in this discharge curve, one burst of five shots was fired, followed by a second burst of seven shots.

As illustrated in FIG. 3, the cyclic rate of fire during the first burst is higher than the cyclic rate of fire during the second burst, which highlights a change in behavior that may be related to a technical problem (weapon overheat, dirt or inadequate lubrication, for example). The cyclic rate of fire of the first burst is 500 rounds per minute while the cyclic rate of fire of the second burst is 333 rounds per minute. This difference results in a decrease in the residual voltage recorded during the next firing.

FIG. 4 shows one particular example of a discharge curve of the RC network for measuring the effective rate of fire. Like in FIG. 3, the voltage V across the terminals of the capacitor (on the y-axis) is shown as a function of time t (on the x-axis). The constant of the RC circuit is 60 seconds in this case.

To result in this discharge curve, a first burst of 10 shots was fired (at time t=0), followed by a burst of three shots (at time t=3 s) and ending in two sporadic shots (at t=20 s and t=30 s).

The effective rate of fire is representative of the number of shots fired by the user over a given time period, and hence the heating of the barrel. In this case, what matters is the history of the curve of the RC circuit, unlike in the case of measuring the cyclic rate of fire. The principle for being able to calculate the effective rate of fire of a weapon lies in the charge that is injected into the RC circuit on each firing having to be constant. In this example, the injected charge results in an incrementation by 0.1 volt on each firing.

1. A device for measuring an effective and/or cyclic rate of fire for a weapon, the device comprising:
a self-powered system configured to recover energy from firing the weapon;
at least one RC accumulator network comprising a capacitor and a resistor in parallel;
a voltage measurement element configured to measure a voltage across terminals of the capacitor;
an electronic device configured to calculate the cyclic rate of fire and/or the effective rate of fire on the basis of a value measured by the voltage measurement element;
the self-powered system being arranged so as to charge said capacitor on each firing.

2. The device as claimed in claim 1, wherein the self-powered system is configured so as either to inject a predetermined constant charge on each firing or to impose a constant difference in potential across the terminals of the capacitor on each firing.

3. The device as claimed in claim 1, wherein a time constant of the RC accumulator network is chosen to represent the dynamics of the effective rate of fire.

4. The device as claimed in claim 3, wherein the time constant of the RC accumulator network is between 1 s and 3600 s.

5. The device as claimed in claim 1, wherein a time constant of the RC accumulator network is chosen to represent dynamics of the cyclic rate of fire.

6. The device as claimed in claim 5, wherein the time constant of the RC accumulator network is between 10 ms and 300 ms.

7. The device as claimed in claim 1, wherein the voltage measurement element comprises an electronic device comprising optocouplers configured to measure a value of the difference in potential across the terminals of the capacitor.

8. The device as claimed in claim 7, further comprising a storage memory configured to store the value of the difference in potential across the terminals of the capacitor during firing.

9. A weapon including at least one measurement device as claimed in claim 1.

10. A method for measuring an effective and/or cyclic rate of fire a weapon, comprising the following steps:
recovering energy from firing the weapon;
injecting a predetermined charge into the a capacitor using said energy or applying a difference in potential to said capacitor using said energy;
gradually discharging the capacitor through the a resistor; and
measuring the a difference in potential across the terminals of the capacitor during firing.

11. The measurement method as claimed in claim 10, comprising an additional step of calculating the cyclic rate of fire using a discharge curve of the resistor and the capacitor.

12. The measurement method as claimed in claim 10, comprising an additional step of calculating the effective rate of fire using a discharge curve of the resistor and the capacitor.
